(19) United States
(12) Patent Application Publication
(10) Pub. No.: US 2025/0264752 A1
(43) Pub. Date: Aug. 21, 2025

(54) DISPLAY DEVICE AND ELECTRONIC APPARATUS

(71) Applicant: Sharp Display Technology Corporation, Kameyama City (JP)

(72) Inventors: Yuuki SHIBATA, Kameyama City (JP); Hiroto Akiyama, Kameyama City (JP)

(21) Appl. No.: 19/033,710

(22) Filed: Jan. 22, 2025

(30) Foreign Application Priority Data
Feb. 19, 2024 (JP) 2024-022811

(51) Int. Cl. G02F 1/1335; G02F 1/1339

(52) U.S. Cl. CPC G02F 1/133512; G02F 1/1339

(57) ABSTRACT

A display device includes a first substrate, a second substrate, a vacuum layer, a first seal portion, a light-blocking layer, and a first translucent layer. The first substrate has a principal surface that is divided into a display area and a non-display area. The first seal portion surrounds the vacuum layer. The light-blocking layer is provided with a first opening facing the vacuum layer and a second opening facing the vacuum layer. The second opening is placed at a spacing from the first opening. The first translucent layer is disposed not to overlap the first opening but to overlap the second opening.

### BACKGROUND

### 1. Field

The present disclosure relates to a display device and an electronic apparatus with a sufficiently ensured amount of transmitted light and a reduction in change in hue of the transmitted light.

### 2. Description of the Related Art

As an example of a liquid crystal display device that is a type of display device, a liquid crystal display device described in Japanese Unexamined Patent Application Publication No. 2019-184828 has conventionally been known. The liquid crystal display device described in Japanese Unexamined Patent Application Publication No. 2019-184828 allows light from a camera to be transmitted through part of a liquid crystal panel. The liquid crystal panel is configured such that a retardation in a liquid crystal layer in a camera light transmission area through which the light from the camera is transmitted is R1=mλ (where m is a positive integer and λ is the wavelength of light that is transmitted through the liquid crystal layer). Further, a retardation in the liquid crystal layer in a camera light non-transmission area excluding the camera light transmission area is R2=λ/2(2k+1) (where k is 0 and an integer).

According to Japanese Unexamined Patent Application Publication No. 2019-184828, in a case where polarized light from an outside source falls on the camera via the liquid crystal layer, an adverse effect on a camera image by birefringence of the light can be avoided. However, in the camera light transmission area, a pair of alignment films are placed in such a manner that the liquid crystal layer is sandwiched therebetween. For this reason, light traveling toward the camera is absorbed by the pair of alignment films when transmitted through the alignment films, and the tint of the alignment films is reflected in the hue of the transmitted light. As a result, the brightness and hue of an image that is taken by the camera might be different from what they are originally intended to be.

It is desirable to sufficiently ensure an amount of transmitted light and reduce a change in hue of the transmitted light.

### SUMMARY

According to an aspect of the disclosure, there is provided a display device including a first substrate, a second substrate, a vacuum layer, a first seal portion, a light-blocking layer, and a first translucent layer. The first substrate has translucency and has a principal surface that is divided into a display area where an image is displayed and a non-display area where the image is not displayed. The second substrate has translucency, and is placed at a spacing from the first substrate. The vacuum layer is sandwiched between the first substrate and the second substrate and placed in part of the non-display area. The first seal portion is sandwiched between the first substrate and the second substrate, and surrounds the vacuum layer. The light-blocking layer is provided on a principal surface of the first substrate that faces toward the vacuum layer, placed in at least the non-display area, and configured to block light. The first translucent layer has translucency, is provided on a principal surface of at least either the first substrate or the second substrate that faces toward the vacuum layer, and is placed in part of the non-display area. The light-blocking layer is provided with a first opening facing the vacuum layer and a second opening facing the vacuum layer, and the second opening is placed at a spacing from the first opening. The first translucent layer is disposed not to overlap the first opening but to overlap the second opening.

According to an aspect of the disclosure, there is provided an electronic apparatus including the display device described above, an imaging element located opposite the first substrate behind the second substrate and disposed to overlap the first opening, and a light-receiving element or a light-emitting element located opposite the first substrate behind the second substrate and disposed to overlap the second opening.

### BRIEF DESCRIPTION OF THE DRAWINGS

FIG. 1 is a plan view of an electronic apparatus according to Embodiment 1;

FIG. 2 is a cross-sectional view of the electronic apparatus according to Embodiment 1 as taken along line ii-ii in FIG. 1;

FIG. 3 is a plan view showing a pixel array of a liquid crystal panel of a liquid crystal display device provided in the electronic apparatus according to Embodiment 1;

FIG. 4 is a cross-sectional view showing a cross-sectional configuration of a display area of the liquid crystal panel according to Embodiment 1;

FIG. 5 is a plan view showing a configuration of a portion of a non-display area of the liquid crystal panel according to Embodiment 1 that overlaps a vacuum layer;

FIG. 6 is a cross-sectional view of the liquid crystal panel according to Embodiment 1 as taken along line vi-vi in FIG. 5;

FIG. 7 is a cross-sectional view of the liquid crystal panel according to Embodiment 1 as taken along line vii-vii in FIG. 5;

FIG. 8 is a table showing experimental results of Comparative Experiment 1 according to Embodiment 1;

FIG. 9 is a plan view showing a configuration of a portion of a non-display area of a liquid crystal panel according to Embodiment 2 that overlaps a vacuum layer; and

FIG. 10 is a cross-sectional view of the liquid crystal panel according to Embodiment 2 as taken along line x-x in FIG. 9.

### DESCRIPTION OF THE EMBODIMENTS

### Embodiment 1

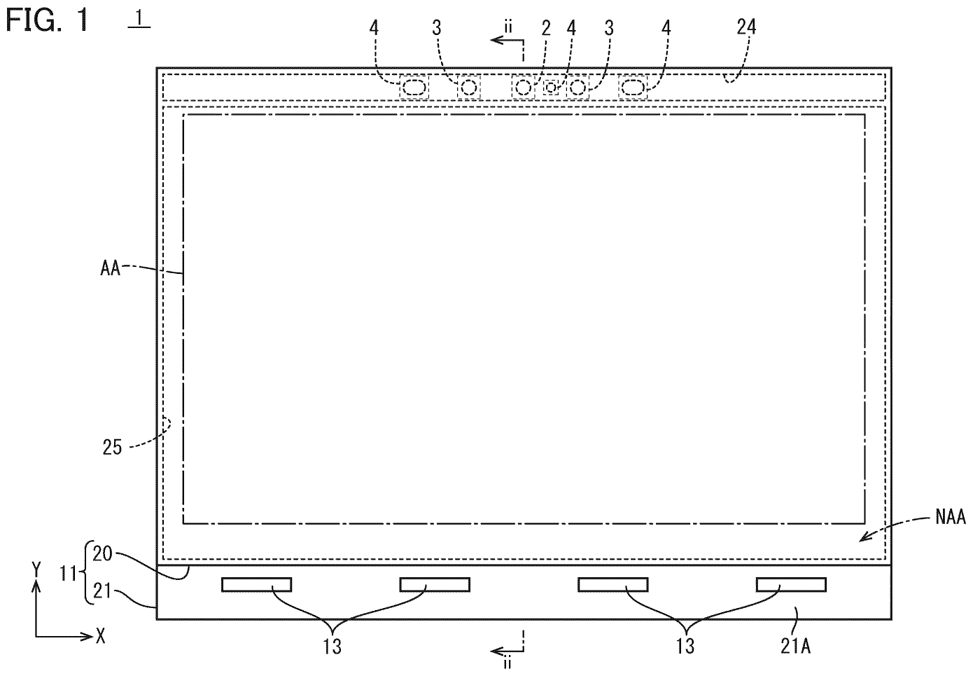

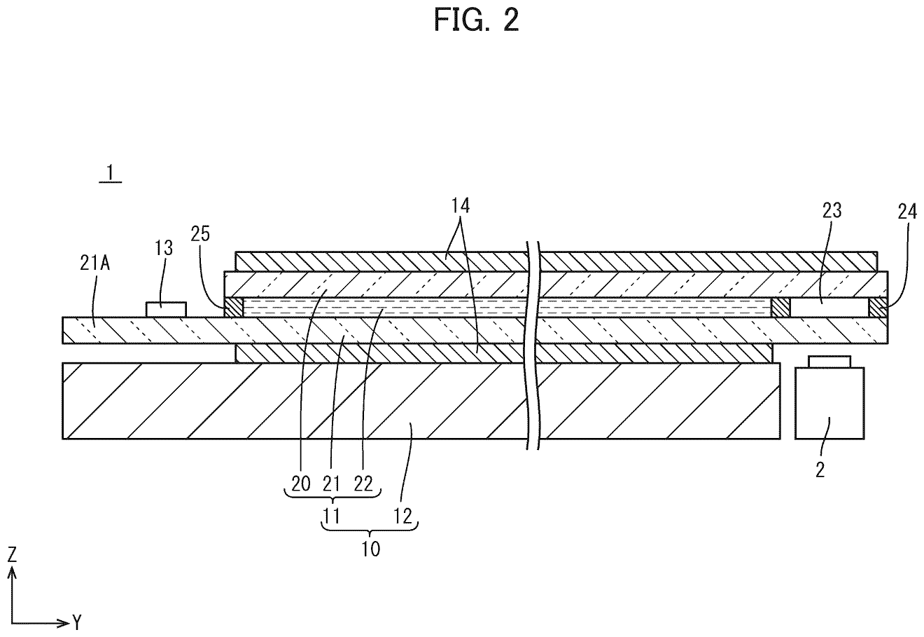

Embodiment 1 is described with reference to FIGS. 1 to 8. The present embodiment illustrates an electronic apparatus 1 including a liquid crystal display device 10. Note that some of the drawings show an X axis, a Y axis, and a Z axis and are drawn so that the direction of each axis is an identical direction in each drawing. Further, FIGS. 2, 4, 6, and 7 show front side up and back side down.

As shown in FIG. 1, the electronic apparatus 1 includes a liquid crystal display device 10 formed in the shape of a horizontally long quadrangle, an imaging element 2, a light-receiving element 3, and a light-emitting element 4. The imaging element 2, the light-receiving element 3, and the light-emitting element 4 are each placed at the back of (behind) the liquid crystal display device 10. Specific examples of the electronic apparatus 1 include a tablet terminal, a laptop personal computer, and a smartphone. FIG. 1 uses dashed lines to illustrate the imaging element 2, the light-receiving element 3, and the light-emitting element 4, which are placed at the back of the liquid crystal display device 10.

As shown in FIGS. 1 and 2, the liquid crystal display device 10 includes at least a liquid crystal panel (display device, display panel) 11 configured to display an image and a backlight device (lighting device) 12 serving as an outside light source configured to illuminate the liquid crystal panel 11 with light for use in display. The backlight device 12 is placed at the back of the liquid crystal panel 11. The backlight device 12 includes a light source (such as an LED) configured to emit white light, an optical member configured to convert the light from the light source into planar light by imparting an optical effect to the light, or other components.

As shown in FIG. 1, the liquid crystal panel 11 has a screen (principal surface) a central portion of which serves as a display area AA where an image is displayed. On the other hand, a frame-shaped outer peripheral portion of the screen of the liquid crystal panel 11 that surrounds the display area AA serves as a non-display area NAA where the image is not displayed. As shown in FIG. 2, the liquid crystal panel 11 includes a pair substrates 20 and 21 bonded to each other. A front one of the two substrates 20 and 21 is a counter substrate (first substrate) 20, and a back one of the two substrates 20 and 21 is an array substrate (second substrate) 21. The counter substrate 20 and the array substrate 21 are each made of glass and include various types of films joined on top of each other on the inner surfaces of the substrates by using a known photolithographic process or other processes. Specifically, the counter substrate 20 and the array substrate 21 are made of an inorganic glass material that is substantially transparent and superior in translucency (such as alkali-free glass or quartz glass) and have a refractive index of, for example, approximately 1.5.

As shown in FIGS. 1 and 2, while the counter substrate 20 has a short-side dimension that is shorter than a short-side dimension of the array substrate 21, the counter substrate 20 is bonded to the array substrate 21 so that a first end of the counter substrate 20 in a short-side direction (Y-axis direction) is aligned with a first end of the array substrate 21 in the short-side direction. Accordingly, a second end of the array substrate 21 in the short-side direction serves as a protruding area (exposed area) 21A protruding laterally with respect to the counter substrate 20 and not overlapping the counter substrate 20. The protruding area 21A is provided with drivers (signal supply units) 13 for the supply of various types of signals. The driver 13 is COG (chip on glass) mounted on the protruding area 21A of the array substrate 21. The drivers 13 are each composed of an LSI chip having a driving circuit inside and process various types of signals that are supplied from an outside source. Further, connected to the protruding area 21A is a flexible substrate through which signals from an external signal supply source (such as a control substrate) are supplied to the drivers 13.

Sandwiched between the two substrates 20 and 21 are a liquid crystal layer (medium layer) 22 containing liquid crystal molecules constituting a substance whose optical properties change in the presence of the application of an electric field and a vacuum layer 23 containing almost no air. The liquid crystal layer 22 is disposed to overlap the whole of the display area AA. The vacuum layer 23 is disposed to overlap part of the non-display area NAA. In particular, the vacuum layer 23 is disposed to overlap an end side portion of the non-display area NAA opposite (in FIG. 2, right) the protruding area 21A (drivers 13) in the Y-axis direction and falls within a horizontally long range extending along the X-axis direction (see FIG. 1). Sandwiched between the two substrates 20 and 21 is a first seal portion 24 surrounding the vacuum layer 23 (part of the non-display area NAA) and a second seal portion 25 surrounding the liquid crystal layer 22 (display area AA). The first seal portion 24 is formed in the shape of a long and thin horizontally long quadrangular frame (endless ring) in a plan view so as to surround the vacuum layer 23 and can keep the vacuum layer 23 under vacuum. The second seal portion 25 is formed in the shape of a horizontally long frame in a plan view so as to surround the liquid crystal layer 22 and can keep the liquid crystal layer 22 sealed. The first seal portion 24 and the second seal portion 25 are used in common as a portion located at a boundary between the display area AA and the non-display area NAA in the Y-axis direction (i.e. a portion that separates the liquid crystal layer 22 and the vacuum layer 23 from each other). Note that polarizing plates 14 are attached separately to each of the outer surfaces of the two substrates 20 and 21.

As shown in FIG. 2, the backlight device 12 is disposed to overlap the whole of the display area AA and part of the non-display area NAA (excluding the vacuum layer 23) of the liquid crystal panel 11. Meanwhile, the imaging element 2, the light-receiving element 3, and the light-emitting element 4 are disposed to overlap part of the non-display area NAA (vacuum layer 23) of the liquid crystal panel 11. That is, the imaging element 2, the light-receiving element 3, and the light-emitting element 4 are disposed to be adjacent to the backlight 12 in the Y-axis direction. The imaging element 2 can receive, through the liquid crystal panel 11, light falling on the liquid crystal panel 11 from the front and take an image based on the light thus received. The light-receiving element 3 can receive, through the liquid crystal panel 11, light falling on the liquid crystal panel 11 from the front. The light-receiving element 3 is, for example, an illuminance sensor configured to receive visible light or an infrared sensor or an infrared camera configured to receive infrared radiation. The light-emitting element 4 can emit light forward and can cause the light thus emitted to exit to an area outside the front of the liquid crystal panel 11 through the liquid crystal panel 11. The light-emitting element 4 is, for example, an infrared LED configured to emit infrared radiation or an LED configured to emit visible light. Note that although FIG. 2 representatively illustrates the imaging element 2, the light-receiving element 3 and the light-emitting element 4 are placed in the same manner as the imaging element 2.

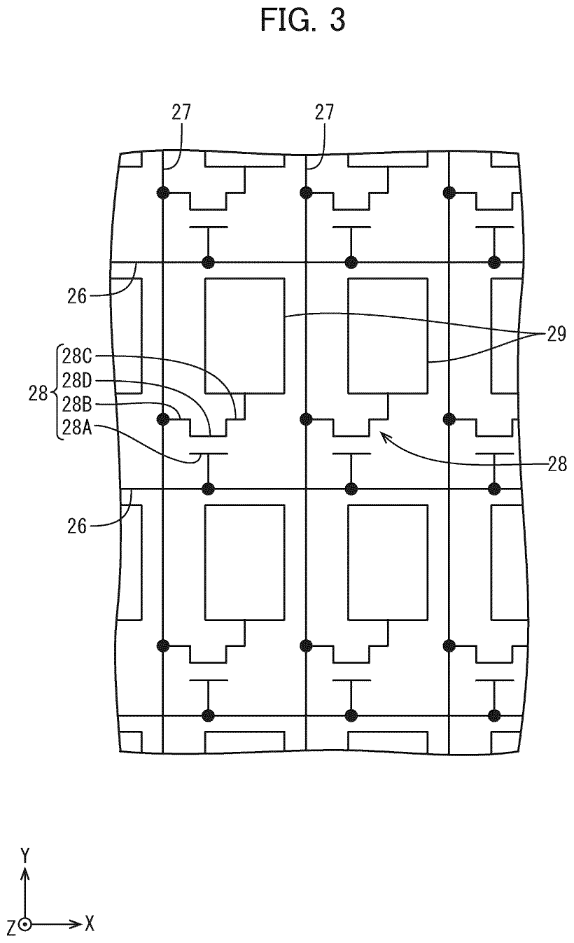

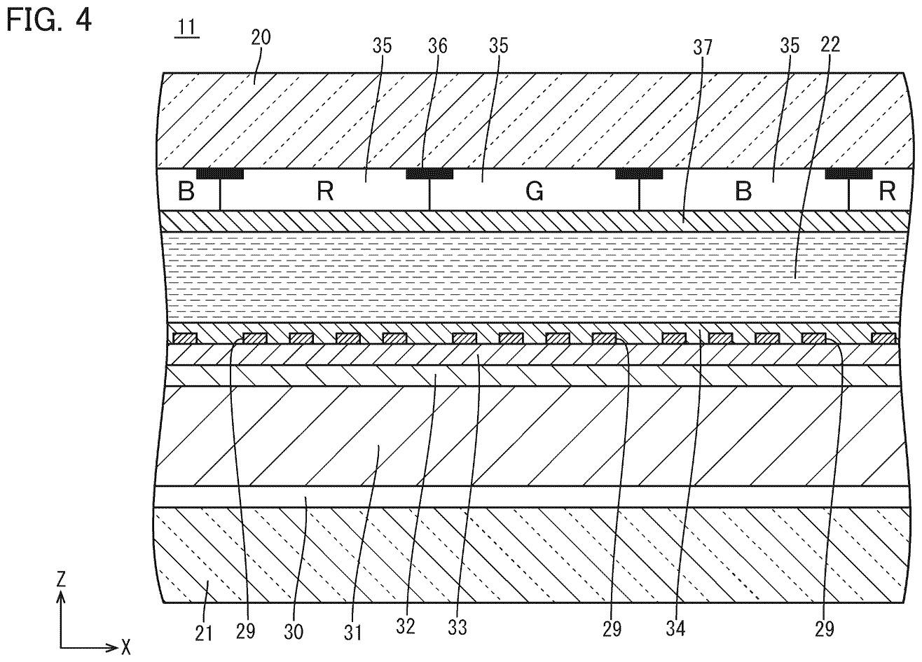

Next, a configuration of the display area AA of the liquid crystal panel 11 is described with reference to FIGS. 3 and 4. On the inner surface of the array substrate 21 in the display area AA, as shown in FIG. 3, a plurality of gate lines (scanning lines) 26 and a plurality of source lines (pixel lines) 27 are arranged in gridlike fashion. Near intersections of the gate lines 26 and the source lines 27, TFTs (switching elements, thin-film transistors) 28 and pixel electrodes 29 are provided. The gate lines 26 extend substantially along the X-axis direction in such a manner as to cross the display area AA, and are each connected to gate electrodes 28A of corresponding ones of the TFTs 28. The plurality of gate lines 26 are placed at spacings from each other in the Y-axis direction. The source lines 27 extend substantially along the Y-axis direction in such a manner as to traverse the display area AA longitudinally, and are each connected to source electrodes 28B of corresponding ones of the TFTs 28. The plurality of source lines 27 are placed at spacings from each other in the X-axis direction. While the gate lines 26 and the source lines 27 intersect each other, the gate lines 26 and the source lines 27 are insulated from each other by an insulating film (gate insulating film 39, which will be described later) sandwiched therebetween. The plurality of TFTs 28 and the plurality of pixel electrodes 29 are regularly arrayed along the X-axis direction and the Y-axis direction to be planarly arranged in a matrix (rows and columns). The pixel electrodes 29 are each connected to a drain electrode 28C a corresponding one of the TFTs 28. The pixel electrodes 29 are made of a transparent electrode material such as ITO (indium tin oxide). Each of the TFTs 28 has a semiconductor component 28D in addition to the aforementioned gate electrode 28A, the aforementioned source electrode 28B, and the aforementioned drain electrode 28C. The semiconductor component 28D is made of a semiconductor material and connected to the source electrode 28B and the drain electrode 28C. Moreover, when driven in accordance with scanning signals that are supplied to the gate lines 26, the TFTs 28 charge the pixel electrodes 29 to potentials based on image signals (data signals) that are supplied to the source lines 27. Note that FIG. 4 illustrates the aforementioned gate lines 26, the aforementioned source lines 27, and the aforementioned TFTs 28 as a “pixel circuit unit 30” in a simplistic form.

In the display area AA of the array substrate 21 of the liquid crystal panel 11, as shown in FIG. 4, the pixel circuit unit 30, a planarizing film 31, a common electrode 32, a second interlayer insulating film 33, the pixel electrodes 29, and a first alignment film (alignment film) 34 are provided in this order from the bottom. Of these components, the common electrode 32 is made of a transparent electrode material as is the case with the pixel electrodes 29. The common electrode 32 has a size about equal to that of the display area AA as a whole. The common electrode 32 is disposed to overlap all pixel electrodes 29 via the second interlayer insulating film 33. The common electrode 32 is supplied with a common potential (reference potential). Accordingly, a potential difference based on the potentials charged to the pixel electrodes 29 is generated between the common electrode 32 and the pixel electrodes 29. This potential difference can be used to control an alignment state of liquid crystal molecules contained in the liquid crystal layer 22. The first alignment film 34 for aligning the liquid crystal molecules contained in the liquid crystal layer 22 is provided at a higher layer than the pixel electrodes 29 (i.e. at the innermost surface of the array substrate 21). The first alignment film 34 is made of polyimide or other polymers and has a refractive index of, for example, approximately 1.6.

In the display area AA of the counter substrate 20 of the liquid crystal panel 11, as shown in FIG. 4, a large number of color filters 35 are provided in such positions as to overlap the pixel electrodes 29 of the array substrate 21. The color filters 35 are arrayed in stripes as a whole such that three colors, namely red (R), green (G), and blue (B), are repeatedly and alternately arranged along the X-axis direction and those arrangements of colors extend along the Y-axis direction. Each color of color filter 35 faces a corresponding one of the pixel electrodes 29 of the array substrate 21. In the display area AA of the counter substrate 20, a black matrix 36 is provided so that a color mixture can be avoided by partitioning adjacent ones of the color filters 35 from each other. The black matrix 36 is made of a light-blocking material such as carbon black or a metal material and has a superior light blocking effect (light absorption properties). The black matrix 36 is located at a lower layer (i.e. closer to the counter substrate 20) than the color filters 35. The black matrix 36 is in such gridlike fashion as to overlap the gate lines 26 and the source lines 27. A second alignment film (alignment film) 37 for aligning the liquid crystal molecules contained in the liquid crystal layer 22 is provided at a higher layer than space between the color filters 35 (i.e. at the innermost surface of the counter substrate 20). As is the case with the first alignment film 34, the second alignment film 37 is made of polyimide or other polymers and has a refractive index of, for example, approximately 1.6.

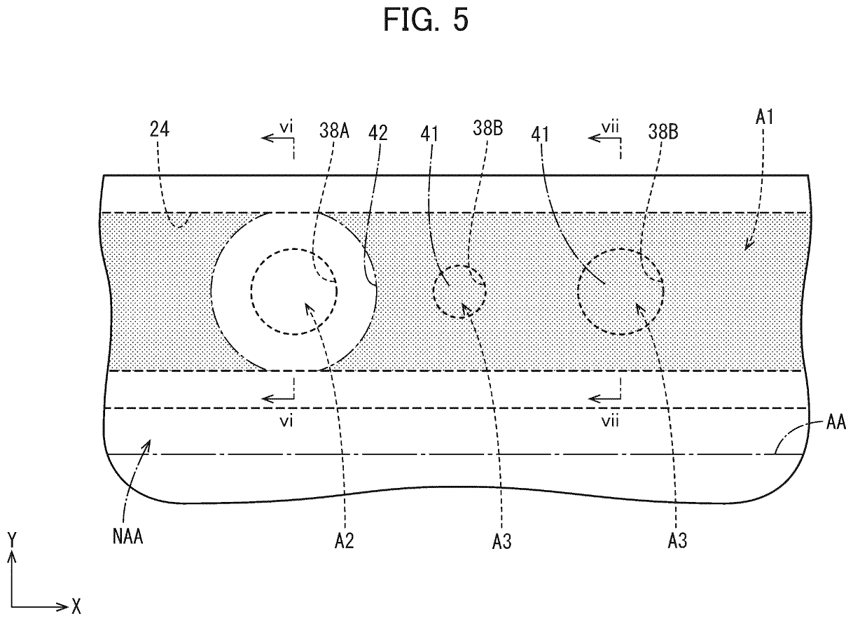

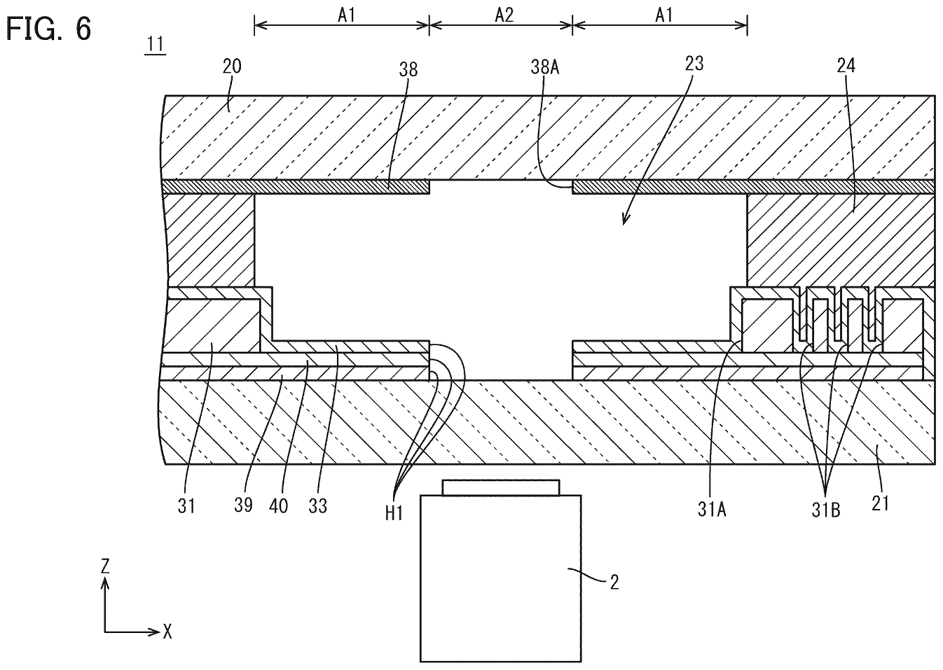

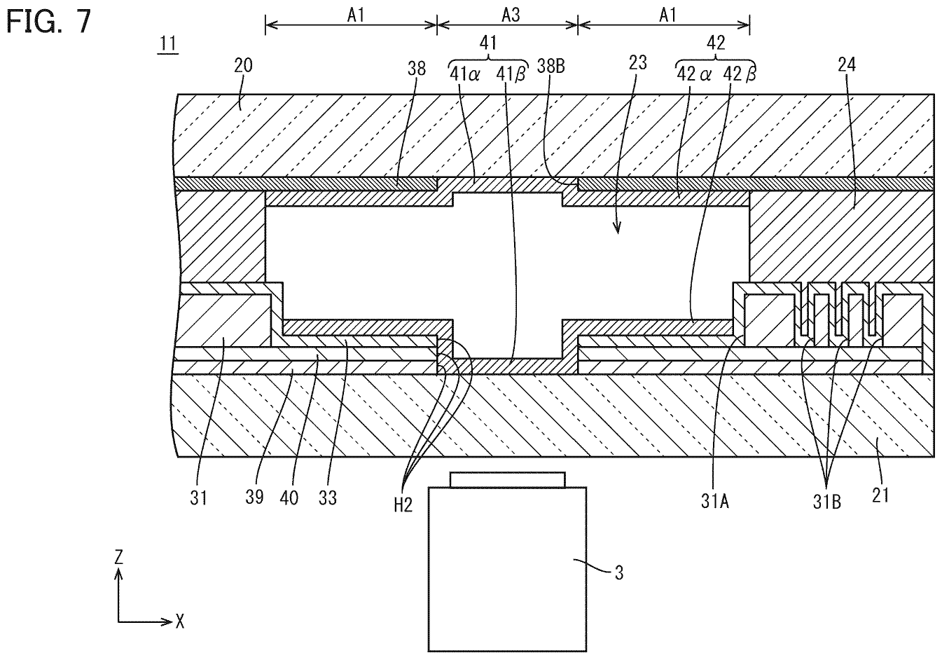

Next, a configuration of a portion of the non-display area NAA of the liquid crystal panel 11 that overlaps the vacuum layer 23 is described with reference to FIGS. 5 to 7. On a principal surface of the counter substrate 20 that faces toward the vacuum layer 23 (i.e. inward), as shown in FIGS. 6 and 7, a light-blocking layer 38 that blocks light is provided. The light-blocking layer 38 is substantially solidly placed over the whole area of the non-display area NAA of the principal surface of the counter substrate 20. Blocking of light by the light-blocking layer 38 makes it hard to view from outside a structure that is present in the non-display area NAA of the liquid crystal panel 11. The light-blocking layer 38 is made of the same light-blocking material as the black matrix 36 placed in the display area AA and is formed in an identical step in manufacturing the array substrate 21. A portion of the light-blocking layer 38 that overlaps the vacuum layer 23 is provided with a first opening 38A and a second opening 38B. As shown in FIG. 5, the first opening 38A and the second opening 38B are disposed to form a line along the X-axis direction, and are arrayed at a spacing from each other in the X-axis direction. As shown in FIGS. 5 and 6, one first opening 38A is provided in such a position as to overlap the imaging element 2. The first opening 38A is disposed to face the vacuum layer 23. The first opening 38A allows light falling on the counter substrate 20 from outside the front to enter the imaging element 2. This allows the imaging element 2 to take an image. As shown in FIGS. 5 and 7, a plurality of the second openings 38B are provided in such positions as to overlap the light-receiving element 3 and the light-emitting element 4, and are placed at spacings from the first opening 38A in the X-axis direction. Although FIG. 7 representatively illustrates the light-receiving element 3, the light-emitting element 4 is placed in the same manner as the light-receiving element 3. Each of the second openings 38B is disposed to face the vacuum layer 23. The second opening 38B that overlaps the light-receiving element 3 allows light falling on the counter substrate 20 from outside the front to enter the light-receiving element 3. This allows the light-receiving element 3, for example, to detect an amount of light. The second opening 38B that overlaps the light-emitting element 4 allows light emitted from the light-emitting element 4 to exit to an area outside the front of the counter substrate 20.

Let it be assumed below that as shown in FIGS. 5 to 7, areas of the counter substrate 20 and the array substrate 21 that overlap the vacuum layer 23 (i.e. areas surrounded by the first seal portion 24) include a first area A1 serving as a range that overlaps the light-blocking layer 38, a second area A2 serving as a range that overlaps the first opening 38A, and a third area A3 serving as a range that overlaps the second opening 38B.

Note here that as shown in FIGS. 6 and 7, light (outside light) that is present on the front of the liquid crystal panel 11 is shone on the counter substrate 20 from a side opposite to the vacuum layer 23. In a portion (i.e. the first area A1) of the counter substrate 20 that overlaps the light-blocking layer 38, while a large portion of the light is transmitted through the counter substrate 20 and absorbed by the light-blocking layer 38, a portion of the light is reflected off a pair of principal surfaces of the counter substrate 20 (i.e. a principal surface of the counter substrate 20 that faces toward the vacuum layer 23 and a principal surface of the counter substrate 20 that faces away from the vacuum layer 23). On the other hand, in portions (i.e. the second area A2 and the third area A3) of the counter substrate 20 that overlap the first opening 38A and the second opening 38B, while a large portion of the light is transmitted through the counter substrate 20 and enters the vacuum layer 23 through the first opening 38A and the second opening 38B, a portion of the light is reflected off the pair of principal surfaces of the counter substrate 20. The light having entered the vacuum layer 23 is absorbed by the light-blocking layer 38 to some extent in the process of repeating reflection within the vacuum layer 23. For this reason, the amount of light that exits from within the vacuum layer 23 through the first opening 38A and the second opening 38B toward the counter substrate 20 might become smaller than the amount of light that falls on the vacuum layer 23. In particular, a decrease in the amount of light that exits through the second opening 38B causes a difference in appearance between the portion (first area A1) of the counter substrate 20 that overlaps the light-blocking layer 38 and a portion (third area A3) of the counter substrate 20 that overlaps the second opening 38B, and this difference may lead to deterioration in appearance.

At a principal surface of the array substrate 21 that faces toward the vacuum layer 23 (inward), as shown in FIGS. 6 and 7, a gate insulating film 39 and a first interlayer insulating film 40 are provided in addition to the aforementioned planarizing film 31 and the aforementioned second interlayer insulating film 33. The gate insulating film 39 is located closest to the array substrate 21, and the first interlayer insulating film 40 is located between the gate insulating film 39 and the planarizing film 31. Note that the gate insulating film 39 and the first interlayer insulating film 40 are also provided in the display area AA. The planarizing film 31 is selectively not formed in a range of the non-display area NAA that overlaps the vacuum layer 23. That is, the planarizing film 31 is provided with a first groove portion 31A that overlaps the vacuum layer 23. As is the case with the vacuum layer 23, the first groove portion 31A is formed in a thin and long horizontally long range along the X-axis direction. Further, a portion of the planarizing film 31 that overlaps a portion of the first seal portion 24 (i.e. a portion of the first seal portion 24 that is not used in common) is provided with a plurality of second groove portions 31B extending along a direction of extension of the first seal portion 24. The second groove portions 31B enhance the adhesion strength of the first seal portion 24. Note that the second groove portions 31B are also provided in a portion of the second seal portion 25 (i.e. a portion of the second seal portion 25 that is not used in common) in addition to the first seal portion 24. The gate insulating film 39, the first interlayer insulating film 40, and the second interlayer insulating film 33 are selectively not formed in ranges of the non-display area NAA that overlap the first opening 38A and the second opening 38B of the light-blocking layer 38. That is, the gate insulating film 39, the first interlayer insulating film 40, and the second interlayer insulating film 33 are provided with first holes H1 that overlap the first opening 38A and that communicate with one another and second holes H2 that overlap the second opening 38B and that communicate with one another.

On principal surfaces of the counter substrate 20 and the array substrate 21 of the liquid crystal panel 11 according to the present embodiment that face toward the vacuum layer 23, as shown in FIGS. 5 to 7, a first translucent layer 41 and a second translucent layer 42 each having translucency are provided in a range that overlaps a portion of the non-display area NAA when seen in a plan view. FIG. 5 illustrates the range of formation of the first translucent layer 41 and the second translucent layer 42 as a shaded area. The first translucent layer 41 and the second translucent layer 42 are formed in a range of the non-display area NAA surrounded by the first seal portion 24, i.e. the range that overlaps the vacuum layer 23, and are not formed in ranges that overlap the seal portions 24 and 25.

Moreover, as shown in FIGS. 5 to 7, the first translucent layer 41 is disposed not to overlap the first opening 38A but to overlap the second opening 38B. That is, the first translucent layer 41 is not formed in the range (i.e. the second area A2) that overlaps the first opening 38A, and is formed in the range (i.e. the third area A3) that overlaps the second opening 38B. The first translucent layer 41 includes a first translucent layer 41 provided to the counter substrate 20 and a first translucent layer 41 provided to the array substrate 21. In the following, in a case where these first translucent layers 41 are distinguished from each other, the first translucent layer 41 provided to the counter substrate 20 is referred to as a “counter-side first translucent layer (first first translucent layer) 41α”, and the first translucent layer 41 provided to the array substrate 21 is referred to as an “array-side first translucent layer (second first translucent layer) 41B”. The first translucent layer 41 is made of the same material as the alignment films 34 and 37. That is, the first translucent layer 41 is made of polyimide or other polymers and has a refractive index of, for example, approximately 1.6. The first translucent layer 41 is higher in refractive index than both the counter substrate 20 and the array substrate 21.

Since the first translucent layer 41 is disposed not to overlap the first opening 38A but to overlap the second opening 38B, light that is shone from outside the front onto a portion (i.e. the second area A2) of the counter substrate 20 that overlaps the first opening 38A is partially reflected off the pair of principal surfaces of the counter substrate 20 as shown in FIG. 6 without being directly reflected by a pair of principal surfaces of the first translucent layer 41 or being directly transmitted through the first translucent layer 41. On the other hand, light that is shone from outside the front onto the portion (i.e. the third area A3) of the counter substrate 20 that overlaps the second opening 38B is partially reflected off the pair of principal surfaces of the counter substrate 20 and reflected off the pair of principal surfaces of the first translucent layer 41 as shown in FIG. 7. That is, the amount of light that exits from the portion (i.e. the third area A3) of the counter substrate 20 that overlaps the second opening 38B toward the front (i.e. toward the side opposite to the vacuum layer 23) is larger than the amount of light that exits from the portion (i.e. the second area A2) of the counter substrate 20 that overlaps the first opening 38A toward the front. Accordingly, even if the amount of light that exits through the second opening 38B decreases because light having entered the vacuum layer 23 through the second opening 38B is absorbed by the light-blocking layer 38 in the process of repeating reflection within the vacuum layer 23, the amount of light that exits from the portion (i.e. the third area A3) of the counter substrate 20 that overlaps the second opening 38B toward the front can be brought close to the amount of light that exits from the portion (i.e. the first area A1) of the counter substrate 20 that overlaps the light-blocking layer 38 toward the front. This reduces the possibility of a difference between an appearance that is produced by the light traveling from the portion (i.e. the first area A1) of the counter substrate 20 that overlaps the light-blocking layer 38 toward the front and an appearance that is produced by the light traveling from the portion (i.e. the third area A3) of the counter substrate 20 that overlaps the second opening 38B toward the front. That is, this makes it hard for the second opening 38B to be visually recognized a structure that is present in the non-display area NAA. Both the light-receiving element 3 and the light-emitting element 4 are affected by reflection and absorption of light by the first translucent layer 41, as light passing through the second opening 38B is transmitted through the first translucent layer 41; however, the optical performance of the light-receiving element 3 and the light-emitting element 4 is less adversely affected than that of the imaging element 2.

Meanwhile, as shown in FIG. 6, light having entered the vacuum layer 23 and traveling toward a portion (i.e. the second area A2) of the array substrate 21 that overlaps the first opening 38A is hardly affected by reflection or absorption of light by the first translucent layer 41. Accordingly, the amount of light that is transmitted through the portion (i.e. the second area A2) of the array substrate 21 that overlaps the first opening 38A becomes larger than the amount of light that is transmitted through a portion (i.e. the third area A3) of the array substrate 21 that overlaps the second opening 38B, and a change in hue is reduced. As a result of this, the brightness and hue of an image that is taken by the imaging element 2, which is placed opposite the vacuum layer 23 behind the array substrate 21 so as to overlap the first opening 38A, can be brought close to what they are originally intended to be. Moreover, since the first translucent layer 41 is disposed not to overlap the first opening 38A but to overlap the second opening 38B, the light-receiving element 3 and the light-emitting element 4 are hardly seen from outside, whereas the imaging element 2 is daringly easily seen from outside. This brings about improvement in appearance of the electronic apparatus 1.

Further, since, as shown in FIG. 7, the counter substrate 20 and the array substrate 21 are each provided with the aforementioned first translucent layer 41, the light that is shone from outside the front onto the portion (i.e. the third area A3) of the counter substrate 20 that overlaps the second opening 38B is partially reflected off a pair of principal surfaces of the counter-side first translucent layer 41α provided to the counter substrate 20 and reflected of a pair of principal surfaces of the array-side first translucent layer 418 provided to the array substrate 21. This makes it possible to further increase the amount of light that exits from the portion (i.e. the third area A3) of the counter substrate 20 that overlaps the second opening 38B toward the front. This further reduces the possibility of a difference between an appearance that is produced by the light traveling from the portion (i.e. the first area A1) of the counter substrate 20 that overlaps the light-blocking layer 38 toward the front and an appearance that is produced by the light traveling from the portion (i.e. the third area A3) of the counter substrate 20 that overlaps the second opening 38B toward the front.

Further, the refractive index (approximately 1.6) of the first translucent layer 41 is higher than both the refractive indices (approximately 1.5) of the counter substrate 20 and the array substrate 21. In this way, a reflectance of reflected light that is produced at an interface between the first translucent layer 41 and the vacuum layer 23 is higher than a reflectance of reflected light that is produced at an interface between the counter substrate 20 or the array substrate 21 and the vacuum layer 23 if the first translucent layer 41 is not formed. This makes it possible to further increase the amount of light that exits from the portion (i.e. the third area A3) of the counter substrate 20 that overlaps the second opening 38B toward the front, thus further reducing the possibility of a difference between an appearance that is produced by the light traveling from the portion (i.e. the first area A1) of the counter substrate 20 that overlaps the light-blocking layer 38 toward the front and an appearance that is produced by the light traveling from the portion (i.e. the third area A3) of the counter substrate 20 that overlaps the second opening 38B toward the front. Further, since the first translucent layer 41 is made of the same material as the alignment films 34 and 37, the material of the first translucent layer 41 can be applied with no need for a photolithographic step during manufacture. Specifically, for example, using an inkjet device or other devices enables pinpoint application of the material of the first translucent layer 41 to the range surrounded by the first seal portion 24. This makes it possible to easily form the first translucent layer 41.

As shown in FIGS. 5 to 7, the second translucent layer 42 is disposed not to overlap the first opening 38A or the second opening 38B but to overlap the light-blocking layer 38. That is, the second translucent layer 42 is not formed in the ranges (i.e. the second area A2 and the third area A3) that overlap the first opening 38A and the second opening 38B, and is formed in the range (i.e. the first area A1) that overlaps the light-blocking layer 38. The second translucent layer 42 includes a second translucent layer 42 provided to the counter substrate 20 and a second translucent layer 42 provided to the array substrate 21. In the following, in a case where these second translucent layers 42 are distinguished from each other, the second translucent layer 42 provided to the counter substrate 20 is referred to as a “counter-side second translucent layer (first second translucent layer) 42α”, and the second translucent layer 42 provided to the array substrate 21 is referred to as an “array-side second translucent layer (second second translucent layer) 42B”. The second translucent layer 42 is made of the same material as the alignment films 34 and 37 and the first translucent layer 41. That is, the second translucent layer 42 is made of polyimide or other polymers and has a refractive index of, for example, approximately 1.6. The second translucent layer 42 is higher in refractive index than both the counter substrate 20 and the array substrate 21.

Since the second translucent layer 42 is disposed not to overlap the first opening 38A or the second opening 38B but to overlap the light-blocking layer 38, a large portion of light shone from the front onto the portions (i.e. the third area A3) of the counter substrate 20 that overlap the first opening 38A and the second opening 38B is transmitted through the counter substrate 20, enters the vacuum layer 23 through the first opening 38A and the second opening 38B, and is then reflected off a principal surface of the second translucent layer 42 that overlaps the light-blocking layer 38 within the vacuum layer 23. This inhibits the absorption of light by the light-blocking layer 38 within the vacuum layer 23, thus making it possible to increase the amount of light that exits from within the vacuum layer 23 through the first opening 38A and the second opening 38B toward the front (i.e. toward the counter substrate 20).

Further, since, as shown in FIGS. 6 and 7, the aforementioned second translucent layer 42 is provided to the counter substrate 20, the second translucent layer 42 is placed such that the light-blocking layer 38 is sandwiched between the counter substrate 20 and the second translucent layer 42. Reflection by the principal surface of the second translucent layer 42 of light traveling toward the light-blocking layer 38 within the vacuum layer 23 makes it possible to effectively inhibit the absorption of the light by the light-blocking layer 38. This makes it possible to further increase the amount of light that exits from within the vacuum layer 23 through the first opening 38A and the second opening 38B toward the front. Moreover, since the counter substrate 20 and the array substrate 21 are each provided with the second translucent layer 42, the light traveling toward the light-blocking layer 38 within the vacuum layer 23 is reflected by a principal surface of the counter-side second translucent layer 42α provided to the counter substrate 20. This makes it possible to effectively inhibit the absorption of the light by the light-blocking layer 38. Meanwhile, light traveling toward the array substrate 21 within the vacuum layer 23 is reflected by a principal surface of the array-side second translucent layer 42 provided to the array substrate 21. This makes it possible to direct the light toward the second translucent layer 42 provided to the counter substrate 20 or direct the light toward the first opening 38A and the second opening 38B. This makes it possible to further increase the amount of light that exits from within the vacuum layer 23 through the first opening 38A and the second opening 38B toward the front.

Further, as shown in FIGS. 5 to 7, the aforementioned second translucent layer 42 is not formed around the first opening 38A but formed around the second opening 38B. That is, the second translucent layer 42 is not formed in the whole of the first area A1 of both substrates 20 and 21 that overlaps the light-blocking layer 38 and is selectively not formed in an annular region that surrounds the first opening 38A. Accordingly, around the first opening 38A within the vacuum layer 23, light is not reflected by the second translucent layer 42, nor is light transmitted through the second translucent layer 42. As a result of this, light having entered the vacuum layer 23 and traveling toward the portion (i.e. the second area A2) of the array substrate 21 that overlaps the first opening 38A is hardly affected by reflection or absorption of light by the second translucent layer 42; therefore, the amount of light that is transmitted through the portion (i.e. the second area A2) of the array substrate 21 that overlaps the first opening 38A is sufficiently ensured, and a hue is secured.

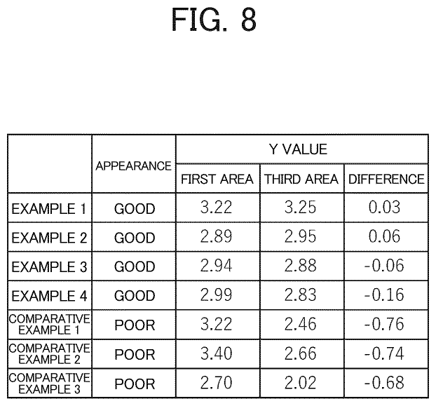

Next, the following Comparative Experiment 1 was conducted to confirm superiority of the liquid crystal panel 11 according to the present embodiment. In Comparative Experiment 1, the brightness of reflected light produced when outside light was shone from outside the front onto each of the liquid crystal panels according to the following Examples 1 to 4 and Comparative Examples 1 to 3 was found, and the quality of appearance was determined. Examples 1 to 4 are liquid crystal panels 11 configured as described up to this paragraph. Examples 1 and 2 differ in light-blocking material of the light-blocking layers 38 and material of the color filters 35 from Examples 3 and 4. Examples 3 and 4 differ in firing temperature at which the color filters 35 are fired in manufacturing the counter substrates 20. Comparative Examples 1 to 3 differ in configuration from the liquid crystal panel 11 described up to this paragraph in that they do not include a first translucent layer 41 or a second translucent layer 42. Comparative Examples 1 to 3 differ in production lot. In Comparative Experiment 1, outside light was shone from outside the front onto each of the liquid crystal panels 11 according to Examples 1 to 4 and Comparative Examples 1 to 3, and light reflected by each liquid crystal panel and traveling toward the front as detected with a predetermined measuring device, and Y values (luminous reflectances: in “%”) were measured as indices of brightness in the first area A1 and the third area A3. In Comparative Experiment 1, the measuring device used was a spectrophotometric colorimeter “CM-700d” manufactured by KONICA MINOLTA, INC. In Comparative Experiment 1, a difference in Y value was calculated by subtracting the Y value of the first area A1 from the Y value of the third area A3 thus measured. Furthermore, a sensory evaluation for determining the quality of appearance was made by shining outside light from outside the front onto each of the liquid crystal panels 11 according to Examples 1 to 4 and Comparative Examples 1 to 3 and letting an inspector visually inspect the first area A1, the third area A3, and the areas therearound. In this sensory evaluation, in a case where a boundary between the first area A1 and the third area A3 (i.e. the shape of an opening edge of the second opening 38B) is visually recognized, it is determined that the “appearance is poor (POOR)”, and in a case where the boundary between the first area A1 and the third area A3 is substantially not visually recognized, it is determined that the “appearance is good (GOOD)”. Experimental results of Comparative Experiment 1 are shown in FIG. 8. FIG. 8 is a table showing, for each of Examples 1 to 4 and Comparative Examples 1 to 3, the result of a determination as to the quality of appearance, the Y values of the first areas A1 and the third area A3, and a difference in Y value calculated by subtracting the Y value of the first area A1 from the Y value of the third area A3. FIG. 8 uses the word “GOOD” for a case where the result of a determination as to the quality of appearance was good, and uses the word “POOR” for a case where the result of a determination as to the quality of appearance was poor.

The experimental results of Comparative Experiment 1 are explained. According to FIG. 8, regarding the results of the determinations as to the quality of appearance, Examples 1 to 4 were all good in appearance, whereas Comparative Examples 1 to 3 were all poor in appearance. Regarding the Y values, in each of Comparative Examples 1 to 3, the Y value of the third area A3 is much smaller than the Y value of the first area A1, and the absolute value of a difference therebetween is at minimum “0.68” and at maximum “0.76”. A presumable reason why the Y value of the third area A3 is much smaller than the Y value of the first area A1 in each of Comparative Examples 1 to 3 is that light having entered the vacuum layer 23 through the second opening 38B of the light-blocking layer 38 was absorbed by the light-blocking layer 38 in the process of being reflected within the vacuum layer 23 and, as a result, the amount of light that exited to an area outside the front through the second opening 38B decreased. On the other hand, in each of Examples 1 to 4, the Y value of the third area A3 is close to the Y value of the first area A1, and the absolute value of a difference therebetween is at minimum “0.03” and at maximum “0.16”. A presumable reason why the Y value of the third area A3 is close to the Y value of the first area A1 in each of Examples 1 to 4 is that reflection by the pair of principal surfaces of the first translucent layer 41 of light traveling from outside the front toward the second opening 38B of the light-blocking layer 38 and reflection by the principal surface of the second translucent layer 42 of light having entered the vacuum layer 23 inhibit the absorption of light by the light-blocking layer 38, thereby sufficiently ensuring the amount of light that exits to an area outside the front through the second opening 38B. As noted above, the absolute values of the differences in Y value in Examples 1 to 4 are much lower than, i.e. are less than a quarter of, the absolute values of the differences in Y value in Comparative Examples 1 to 3. This means that in each of Examples 1 to 4, the first area A1 and the third area A3 are so close in brightness, i.e. in appearance, to each other that it becomes hard to visually recognize the boundary between the first area A1 and the third area A3, and does not contradict the result of a determination as to the quality of appearance.

As described above, a liquid crystal panel (display device) 11 of the present embodiment includes a counter substrate (first substrate) 20, an array substrate (second substrate) 21, a vacuum layer 23, a first seal portion 24, a light-blocking layer 38, and a first translucent layer 41. The counter substrate 20 has translucency and has a principal surface that is divided into a display area AA where an image is displayed and a non-display area NAA where the image is not displayed. The array substrate 21 has translucency, and is placed at a spacing from the counter substrate 20. The vacuum layer 23 is sandwiched between the counter substrate 20 and the array substrate 21 and placed in part of the non-display area NAA. The first seal portion 24 is sandwiched between the counter substrate 20 and the array substrate 21, and surrounds the vacuum layer 23. The light-blocking layer 38 is provided on a principal surface of the counter substrate 20 that faces toward the vacuum layer 23, placed in at least the non-display area NAA, and configured to block light. The first translucent layer 41 has translucency, is provided on a principal surface of at least either the counter substrate 20 or the array substrate 21 that faces toward the vacuum layer 23, and is placed in part of the non-display area NAA. The light-blocking layer 38 is provided with a first opening 38A facing the vacuum layer 23 and a second opening 38B facing the vacuum layer 23. The second opening 38B is placed at a spacing from the first opening 38A. The first translucent layer 41 is disposed not to overlap the first opening 38A but to overlap the second opening 38B.

By surrounding the vacuum layer 23 placed in part of the non-display area NAA, the first seal portion 24 sandwiched between the counter substrate 20 and the array substrate 21 keeps the vacuum layer 23 under vacuum. In a portion of the counter substrate 20 that overlaps the light-blocking layer 38, while a large portion of light shone on the counter substrate 20 from the side opposite to the vacuum layer 23 is transmitted through the counter substrate 20 and absorbed by the light-blocking layer 38, a portion of the light is reflected off a pair of principal surfaces of the counter substrate 20. On the other hand, in portions of the counter substrate 20 that overlap the first opening 38A and the second opening 38B, while a large portion of the light is transmitted through the counter substrate 20 and enters the vacuum layer 23 through the first opening 38A and the second opening 38B, a portion of the light is reflected off the pair of principal surfaces of the counter substrate 20. The light having entered the vacuum layer 23 is absorbed by the light-blocking layer 38 to some extent in the process of repeating reflection within the vacuum layer 23. For this reason, the amount of light that exits from within the vacuum layer 23 through the first opening 38A and the second opening 38B toward the counter substrate 20 becomes smaller than the amount of light that falls on the vacuum layer 23.

Note here that the first translucent layer 41 provided on the principal surface of at least either the counter substrate 20 or the array substrate 21 that faces toward the vacuum layer 23 is disposed not to overlap the first opening 38A but to overlap the second opening 38B. Accordingly, light that is shone on a portion of the counter substrate 20 that overlaps the first opening 38A is partially reflected off the pair of principal surfaces of the counter substrate 20 without being directly reflected by a pair of principal surfaces of the first translucent layer 41 or being directly transmitted through the first translucent layer 41. On the other hand, light that is shone on a portion of the counter substrate 20 that overlaps the second opening 38B is partially reflected off the pair of principal surfaces of the counter substrate 20 and reflected off the pair of principal surfaces of the first translucent layer 41. That is, the amount of light that exits from the portion of the counter substrate 20 that overlaps the second opening 38B toward the side opposite to the vacuum layer 23 is larger than the amount of light that exits from the portion of the counter substrate 20 that overlaps the first opening 38A toward the side opposite to the vacuum layer 23. Accordingly, even if the amount of light that exits through the second opening 38B decreases because light having entered the vacuum layer 23 through the second opening 38B is absorbed by the light-blocking layer 38 in the process of repeating reflection within the vacuum layer 23, the amount of light that exits from the portion of the counter substrate 20 that overlaps the second opening 38B toward the side opposite to the vacuum layer 23 can be brought close to the amount of light that exits from the portion of the counter substrate 20 that overlaps the light-blocking layer 38 toward the side opposite to the vacuum layer 23. This reduces the possibility of a difference in appearance between the portion of the counter substrate 20 that overlaps the light-blocking layer 38 and the portion of the counter substrate 20 that overlaps the second opening 38B. Meanwhile, light having entered the vacuum layer 23 and traveling toward a portion of the array substrate 21 that overlaps the first opening 38A is hardly affected by reflection or absorption of light by the first translucent layer 41. Accordingly, the amount of light that is transmitted through the portion of the array substrate 21 that overlaps the first opening 38A becomes larger than the amount of light that is transmitted through a portion of the array substrate 21 that overlaps the second opening 38B, and a change in hue is reduced. As a result of this, in a case where the imaging element 2 is placed opposite the vacuum layer 23 behind the array substrate 21, the brightness and hue of an image that is taken by the imaging element 2 can be brought close to what they are originally intended to be. The present embodiment makes it possible to sufficiently ensure an amount of transmitted light and reduce a change in hue of the transmitted light.

Further, the counter substrate 20 and the array substrate 21 are each provided with the first translucent layer 41. Light that is shone on the portion of the counter substrate 20 that overlaps the second opening 38B is partially reflected off the pair of principal surfaces of the first translucent layer 41 provided to the counter substrate 20 and reflected off the pair of principal surfaces of the first translucent layer 41 provided to the array substrate 21. This makes it possible to further increase the amount of light that exits from the portion of the counter substrate 20 that overlaps the second opening 38B toward the side opposite to the vacuum layer 23, thus further reducing the possibility of a difference in appearance between the portion of the counter substrate 20 that overlaps the light-blocking layer 38 and the portion of the counter substrate 20 that overlaps the second opening 38B.

Further, the first translucent layer 41 is higher in refractive index than one of the counter and array substrates 20 and 21 that is provided with the first translucent layer 41. A reflectance of reflected light that is produced at an interface between the first translucent layer 41 and the vacuum layer 23 is higher than a reflectance of reflected light that is produced at an interface between the counter substrate 20 or the array substrate 21 and the vacuum layer 23 if the first translucent layer 41 is not formed. This makes it possible to further increase the amount of light that exits from the portion of the counter substrate 20 that overlaps the second opening 38B toward the side opposite to the vacuum layer 23, thus further reducing the possibility of a difference in appearance between the portion of the counter substrate 20 that overlaps the light-blocking layer 38 and the portion of the counter substrate 20 that overlaps the second opening 38B.

Further, the liquid crystal panel 11 further includes a pair of alignment films 34 and 37 provided on principal surfaces of the counter and array substrates 20 and 21 that face toward the vacuum layer 23 and placed in the display area AA, and the first translucent layer 41 is made of a material that is identical to that of the alignment films 34 and 37. In general, the material of the alignment films 34 and 37 is higher in refractive index than the counter substrate 20 and the array substrate 21. Further, since the first translucent layer 41 is made of the same material as the alignment films 34 and 37, the first translucent layer 41 can be easily formed by applying the material of the first translucent layer 41 with no need for a photolithographic step during manufacture.

Further, the liquid crystal panel 11 further includes a second translucent layer 42 having translucency. The second translucent layer 42 is provided on a principal surface of at least either the counter substrate 20 or the array substrate 21 that faces toward the vacuum layer 23 and placed in part of the non-display area NAA. The second translucent layer 42 is disposed not to overlap the first opening 38A or the second opening 38B but to overlap the light-blocking layer 38. A large portion of light shone from the side opposite to the vacuum layer 23 onto the portions of the counter substrate 20 that overlap the first opening 38A and the second opening 38B is transmitted through the counter substrate 20, enters the vacuum layer 23 through the first opening 38A and the second opening 38B, and is then reflected off a principal surface of the second translucent layer 42 that overlaps the light-blocking layer 38 within the vacuum layer 23. This inhibits the absorption of light by the light-blocking layer 38, thus making it possible to increase the amount of light that exits from within the vacuum layer 23 through the first opening 38A and the second opening 38B toward the counter substrate 20.

Further, at least the counter substrate 20 is provided with the second translucent layer 42. In this way, the second translucent layer 42 is placed such that the light-blocking layer 38 is sandwiched between the counter substrate 20 and the second translucent layer 42. Reflection by the principal surface of the second translucent layer 42 of light traveling toward the light-blocking layer 38 within the vacuum layer 23 makes it possible to effectively inhibit the absorption of the light by the light-blocking layer 38. This makes it possible to further increase the amount of light that exits from within the vacuum layer 23 through the first opening 38A and the second opening 38B toward the counter substrate 20.

Further, the counter substrate 20 and the array substrate 21 are each provided with the second translucent layer 42. The light traveling toward the light-blocking layer 38 within the vacuum layer 23 is reflected by a principal surface of the second translucent layer 42 provided to the counter substrate 20. This makes it possible to effectively inhibit the absorption of the light by the light-blocking layer 38. Meanwhile, light traveling toward the array substrate 21 within the vacuum layer 23 is reflected by a principal surface of the second translucent layer 42 provided to the array substrate 21. This makes it possible to direct the light toward the second translucent layer 42 provided to the counter substrate 20 or direct the light toward the first opening 38A and the second opening 38B. This makes it possible to further increase the amount of light that exits from within the vacuum layer 23 through the first opening 38A and the second opening 38B toward the counter substrate 20.

Further, the second translucent layer 42 is not formed around the first opening 38A but formed around the second opening 38B. Around the first opening 38A within the vacuum layer 23, light is not reflected by the second translucent layer 42, nor is light transmitted through the second translucent layer 42. As a result of this, light having entered the vacuum layer 23 and traveling toward the portion of the array substrate 21 that overlaps the first opening 38A is hardly affected by reflection or absorption of light by the second translucent layer 42; therefore, the amount of light that is transmitted through the portion of the array substrate 21 that overlaps the first opening 38A is sufficiently ensured, and a hue is secured.

Further, the liquid crystal panel 11 further includes a second seal portion 25 and a liquid crystal layer 22. The second seal portion 25 is sandwiched between the counter substrate 20 and the array substrate 21, and surrounds the display area AA. The liquid crystal layer 22 is sandwiched between the counter substrate 20 and the array substrate 21 and surrounded by the second seal portion 25. An image can be displayed in the display area AA by controlling an alignment state of liquid crystal molecules contained in the liquid crystal layer 22. The liquid crystal layer 22 is sealed by being surrounded by the second seal portion 25 and avoids leaking out toward the vacuum layer 23 surrounded by the first seal portion 24. Light introduced through the first opening 38A and the second opening 38B better avoids being affected by birefringence caused by the liquid crystal layer 22 than if the liquid crystal layer 22 is formed in the vacuum layer 23.

Further, an electronic apparatus 1 according to the present embodiment includes the liquid crystal panel 11 described above, an imaging element 2 located opposite the counter substrate 20 behind the array substrate 21 and disposed to overlap the first opening 38A, and a light-receiving element 3 or a light-emitting element 4 located opposite the counter substrate 20 behind the array substrate 21 and disposed to overlap the second opening 38B. The imaging element 2 takes an image by utilizing light that is transmitted through the portion of the array substrate 21 that overlaps the first opening 38A. Since the light that is transmitted through the portion of the array substrate 21 that overlaps the first opening 38A is hardly affected by absorption or reflection of light by the first translucent layer 41, the amount of light that is received by the imaging element 2 is sufficiently ensured, and a change in hue of the light is reduced. As a result of this, the brightness and hue of an image that is taken by the imaging element 2 can be brought close to what they are originally intended to be. In a case where the light-receiving element 3 is disposed to overlap the second opening 38B, the light-receiving element 3 can detect, for example, the amount of light by utilizing the light that is transmitted through the portion of the array substrate 21 that overlaps the second opening 38B. In a case where the light-emitting element 4 is disposed to overlap the second opening 38B, light emitted from the light-emitting element 4 exits outward by being transmitted through the portion of the array substrate 21 that overlaps the second opening 38B and transmitted through the counter substrate 20 through the second opening 38B. Both the light-receiving element 3 and the light-emitting element 4 are affected by reflection and absorption of light by the first translucent layer 41, as light passing through the second opening 38B is transmitted through the first translucent layer 41; however, the optical performance of the light-receiving element 3 and the light-emitting element 4 is less adversely affected than that of the imaging element 2. Moreover, since the first translucent layer 41 is disposed not to overlap the first opening 38A but to overlap the second opening 38B, the light-receiving element 3 and the light-emitting element 4 are hardly seen from outside, whereas the imaging element 2 is easily seen from outside. This brings about improvement in appearance of the electronic apparatus 1.

### Embodiment 2

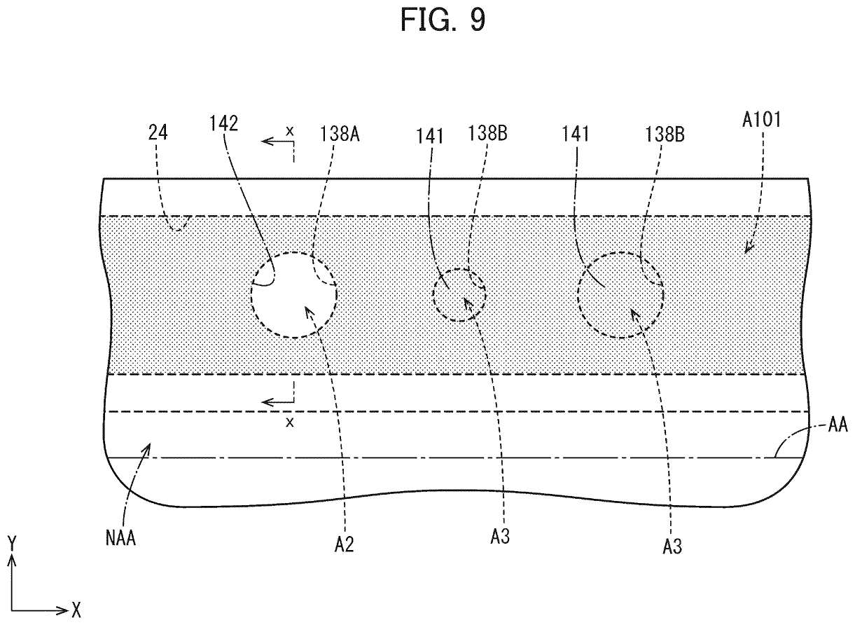

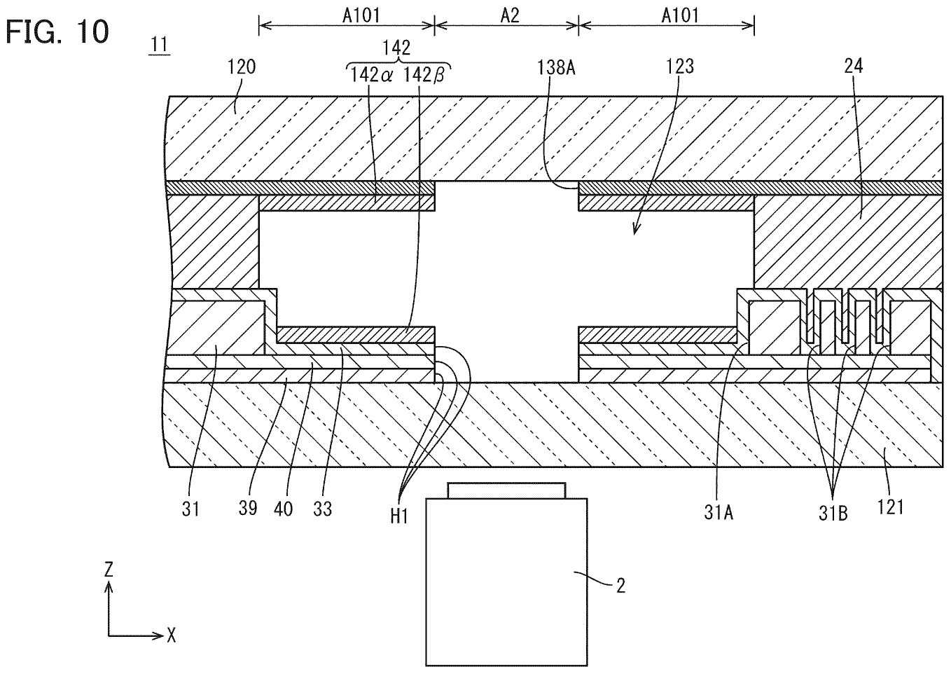

Embodiment 2 is described with reference to FIG. 9 or 10. Embodiment 2 illustrates the case of a change in range of formation of a second translucent layer 142. Note that a repeated description of structures, actions, and effects which are similar to those of Embodiment 1 is omitted.

As shown in FIGS. 9 and 10, the second translucent layer 142 according to the present embodiment is also formed around a first opening 138A of a light-blocking layer 138. That is, the second translucent layer 142 is formed across substantially the whole of a first area A101 of both substrates 120 and 121 that overlaps the light-blocking layer 138. Note that FIG. 9 illustrates the range of formation of a first translucent layer 141 and the second translucent layer 142 as a shaded area. In particular, in the counter substrate 120, substantially the whole of the light-blocking layer 138, which faces a vacuum layer 123, is covered by a counter-side second translucent layer 142α from inside. In the array substrate 121, substantially the whole of an inner surface facing the vacuum layer 123 is covered by an array-side second translucent layer 1428 from inside. Accordingly, light having entered the vacuum layer 123 through the first opening 138A and a second opening 138B from outside the front is reflected by the respective principal surfaces of the counter-side second translucent layer 142α and the array-side second translucent layer 142B both around the first opening 138A and around the second opening 138B. This further inhibits absorption by the light-blocking layer 138 and therefore further increases the amount of light that exits toward an area outside the front through the first opening 138A and the second opening 138B, thus bringing about further improvement in appearance.

### Other Embodiments

The present disclosure is not limited to the embodiments described above with reference to the drawings. The following embodiments may be included in the technical scope of the present disclosure.

(1) Only the counter substrates 20 and 120 or only the array substrates 21 and 121 may be provided with the first translucent layers 41 and 141.

(2) Only the counter substrates 20 and 120 or only the array substrates 21 and 121 may be provided with the second translucent layers 42 and 142.

(3) The material of the first translucent layers 41 and 141 and the second translucent layers 42 and 142 may be different from the material of the alignment films 34 and 37. Specifically, for example, an inorganic insulating material, an organic insulating material, or other materials can be used as the material of the first translucent layers 41 and 141 and the second translucent layers 42 and 142.

(4) The refractive indices of the first translucent layers 41 and 141 and the second translucent layers 42 and 142 may be higher than 1.6 or may be lower than 1.6.

(5) The second translucent layers 42 and 142 may not be formed.

(6) The light-blocking layers 38 and 138 may be configured to have a plurality of the first openings 38A and 138A. In that case, the electronic apparatus 1 is configured to include a plurality of the imaging elements 2.

(7) The light-blocking layers 38 and 138 may each be configured to have only one second opening 38B or 138B. In that case, the electronic apparatus 1 is configured to have one light-receiving element 3 or one light-emitting element 4.

(8) The specific planar shapes of the first openings 38A and 138A can be appropriately changed to those not illustrated. Similarly, the specific planar shapes of the second openings 38B and 138B can be appropriately changed to those not illustrated.

(9) The counter substrates 20 and 120 may each be provided with an overcoat layer located at a higher layer than the color filter 36 and at a lower layer than the second alignment film 37. Providing the overcoat layer causes the second alignment film 37 to be planarized. In that case, as in the case of the planarizing film 31, a portion of the overcoat film that overlaps the vacuum layer 23 or 123 may be selectively removed.

(10) The specific patterns of the first seal portion 24 and the second seal portion 25 in a plan view can be appropriately changed to those not illustrated. The ranges of formation of the vacuum layers 23 and 123 in a plan view can be changed accordingly.

(11) The numbers of insulating films 33, 39, 40 and planarizing films 31 that are provided in the array substrates 21 and 121 can be appropriately changed to those not illustrated.

(12) The number of drivers 13 that are provided can be appropriately changed to that not illustrated.

(13) The planar shape of the liquid crystal panel 11 may be a vertically long oblong, a regular square, a circle, a semicircle, an oval, a trapezoid, or other shapes.

(14) The liquid crystal panel 11 may be of a reflective type or a semi-transmissive type instead of being of a transmissive type.

The present disclosure contains subject matter related to that disclosed in Japanese Priority Patent Application JP 2024-022811 filed in the Japan Patent Office on Feb. 19, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a first substrate having translucency and having a principal surface that is divided into a display area where an image is displayed and a non-display area where the image is not displayed;
a second substrate having translucency, the second substrate being placed at a spacing from the first substrate;
a vacuum layer sandwiched between the first substrate and the second substrate and placed in part of the non-display area;
a first seal portion sandwiched between the first substrate and the second substrate, the first seal portion surrounding the vacuum layer;
a light-blocking layer provided on a principal surface of the first substrate that faces toward the vacuum layer, placed in at least the non-display area, and configured to block light; and
a first translucent layer having translucency, the first translucent layer being provided on a principal surface of at least either the first substrate or the second substrate that faces toward the vacuum layer and placed in part of the non-display area,
wherein
the light-blocking layer is provided with a first opening facing the vacuum layer and a second opening facing the vacuum layer, the second opening being placed at a spacing from the first opening, and
the first translucent layer is disposed not to overlap the first opening but to overlap the second opening.

2. The display device according to claim 1, wherein the first substrate and the second substrate are each provided with the first translucent layer.

3. The display device according to claim 1, wherein the first translucent layer is higher in refractive index than one of the first and second substrates that is provided with the first translucent layer.

4. The display device according to claim 3, further comprising a pair of alignment films provided on principal surfaces of the first and second substrates that face toward the vacuum layer and placed in the display area,
wherein the first translucent layer is made of a material that is identical to that of the alignment films.

5. The display device according to claim 1, further comprising a second translucent layer having translucency, the second translucent layer being provided on a principal surface of at least either the first substrate or the second substrate that faces toward the vacuum layer and placed in part of the non-display area,
wherein the second translucent layer is disposed not to overlap the first opening or the second opening but to overlap the light-blocking layer.

6. The display device according to claim 5, wherein at least the first substrate is provided with the second translucent layer.

7. The display device according to claim 5, wherein the first substrate and the second substrate are each provided with the second translucent layer.

8. The display device according to claim 5, wherein the second translucent layer is not formed around the first opening but formed around the second opening.

9. The display device according to claim 1, further comprising:
a second seal portion sandwiched between the first substrate and the second substrate, the second seal portion surrounding the display area; and
a liquid crystal layer sandwiched between the first substrate and the second substrate and surrounded by the second seal portion.

10. An electronic apparatus comprising:
the display device according to claim 1;
an imaging element located opposite the first substrate behind the second substrate and disposed to overlap the first opening; and
a light-receiving element or a light-emitting element located opposite the first substrate behind the second substrate and disposed to overlap the second opening.
